(19) United States
(12) Patent Application Publication
(10) Pub. No.: US 2018/0272745 A1
(43) Pub. Date: Sep. 27, 2018

(54) INKJET PRINTER AND INKJET PRINTING METHOD

(71) Applicant: SCREEN Holdings Co., Ltd., Kyoto-shi (JP)

(72) Inventor: YOSHIKAZU ICHIOKA, Kyoto (JP)

(21) Appl. No.: 15/872,682

(22) Filed: Jan. 16, 2018

(30) Foreign Application Priority Data
Mar. 21, 2017 (JP) 2017-053870

(51) Int. Cl. B41J 2/21; B41J 2/155

(52) U.S. Cl. CPC B41J 2/2135; B41J 2/155

(57) ABSTRACT

An inkjet printer includes head units each having an upstream head and a downstream head. The downstream head is adjacent to the upstream head as seen in a width direction of a recording medium, and is positioned downstream from the upstream head as seen in a transport direction. Each of the upstream and downstream heads includes a plurality of nozzles, and some of the nozzles in the upstream head and some of the nozzles in the downstream head overlap each other in widthwise position. A controller for the inkjet printer includes a ratio changing part for changing a usage ratio between the nozzles in the upstream head and the nozzles in the downstream head in an overlap region that is a widthwise range in which the overlapping ones of the nozzles are present. The occurrence of color irregularities in the overlap region is suppressed by appropriately setting the usage ratio.

### RELATED APPLICATIONS

This application claims the benefit of Japanese Application No. 2017-53870, filed on Mar. 21, 2017, the disclosure of which is incorporated by reference herein.

### BACKGROUND OF THE INVENTION

### Field of the Invention

The present invention relates to an inkjet printer and an inkjet printing method which print a multi-color image on a recording medium.

### Description of the Background Art

An inkjet printer which records an image on a strip-shaped recording medium by ejecting inks from a plurality of head units while transporting the recording medium has heretofore been known. In the inkjet printer of this type, each of the head units for respective colors, i.e. C, M, Y and K, includes a plurality of recording heads. Each of the recording heads has a plurality of nozzles arranged in the width direction of the recording medium. Adjacent ones of the recording heads as seen in the width direction are disposed so that they are displaced in relation to each other in a transport direction and so that the positions of some of the nozzles thereof as seen in the width direction overlap each other. In such an inkjet printer, there arises a problem such that color irregularities are prone to occur in an overlap region in which the overlapping ones of the nozzles as mentioned above are present.

A conventional technique for reducing the color irregularities in inkjet printers is disclosed, for example, in Japanese Patent Application Laid-Open No. 2014-108549.

Japanese Patent Application Laid-Open No. 2014-108549 discloses that a predetermined number of ejection orifices are arranged in connecting parts of two adjacent ejection orifice rows and eject ink therefrom so that an image recorded by one of the ejection orifice rows which is positioned upstream and an image recorded by the other of the ejection orifice rows which is positioned downstream are formed in an intricate configuration on a recording medium. This is disclosed in Abstract of Japanese Patent Application Laid-Open No. 2014-108549, for example.

Unfortunately, the appearance of color irregularities in the overlap region of the recording heads varies depending on conditions during printing such as the type of recording medium and the type of ink. Thus, there has been a need for a technique capable of appropriately reducing the color irregularities even when these conditions are varied.

### SUMMARY OF THE INVENTION

It is therefore an object of the present invention to provide an inkjet printer and an inkjet printing method which are capable of appropriately suppressing the occurrence of color irregularities in an overlap region in accordance with printing conditions.

The present invention is intended for an inkjet printer for printing a multi-color image on a recording medium. According to the present invention, the inkjet printer comprises: a plurality of head units for ejecting respective inks of different colors toward the recording medium; a transport mechanism for moving the recording medium and the head units relative to each other in a transport direction; and a controller for controlling the operation of ejecting the inks from the head units, each of the head units including an upstream head, and a downstream head adjacent to the upstream head as seen in a width direction orthogonal to the transport direction and positioned downstream from the upstream head as seen in the transport direction, each of the upstream head and the downstream head including a plurality of nozzles arranged in the width direction, some of the nozzles in the upstream head and some of the nozzles in the downstream head overlapping each other in widthwise position, the controller including a ratio changing part for changing a usage ratio between the nozzles in the upstream head and the nozzles in the downstream head in an overlap region that is a widthwise range in which the overlapping ones of the nozzles are present.

The present invention is also intended for a method of inkjet printing a multi-color image on a recording medium by ejecting inks of different colors from respective head units toward the recording medium while moving the recording medium and the head units relative to each other in a transport direction, each of the head units including an upstream head, and a downstream head adjacent to the upstream head as seen in a width direction orthogonal to the transport direction and positioned downstream from the upstream head as seen in the transport direction, each of the upstream head and the downstream head including a plurality of nozzles arranged in the width direction, some of the nozzles in the upstream head and some of the nozzles in the downstream head overlapping each other in widthwise position. According to the present invention, the method comprises the steps of: a) changing a usage ratio between the nozzles in the upstream head and the nozzles in the downstream head in an overlap region that is a widthwise range in which the overlapping ones of the nozzles are present; and b) ejecting the inks in the changed usage ratio from the upstream head and the downstream head.

The inkjet printer according to the present invention is capable of changing the usage ratio between the nozzles in the upstream head and the nozzles in the downstream head in the overlap region. Therefore, the occurrence of color irregularities in the overlap region is suppressed by appropriately setting the usage ratio in accordance with printing conditions.

The inkjet printing method according to the present invention changes the usage ratio between the nozzles in the upstream head and the nozzles in the downstream head in the overlap region. Therefore, the occurrence of color irregularities in the overlap region is suppressed by appropriately setting the usage ratio in accordance with printing conditions.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an inkjet printer;

FIG. 2 is a bottom plan view of a head unit;

FIG. 3 is a block diagram conceptually showing functions of a controller which relate to the proper use of nozzles;

FIG. 4 is a diagram showing a usage ratio rewriting process by means of a ratio changing part;

FIG. 5 shows an example of ejection patterns of upstream nozzles and downstream nozzles in an overlap region;

FIG. 6 shows an example of a chart image;

FIG. 7 is a diagram showing another example of the usage ratio rewriting process by means of the ratio changing part;

FIG. 8 shows another example of the ejection patterns of the upstream nozzles and the downstream nozzles in the overlap region; and

FIG. 9 shows still another example of the ejection patterns of the upstream nozzles and the downstream nozzles in the overlap region.

### DESCRIPTION OF THE PREFERRED EMBODIMENTS

A preferred embodiment according to the present invention will now be described with reference to the drawings.

<1. Configuration of Inkjet Printer>

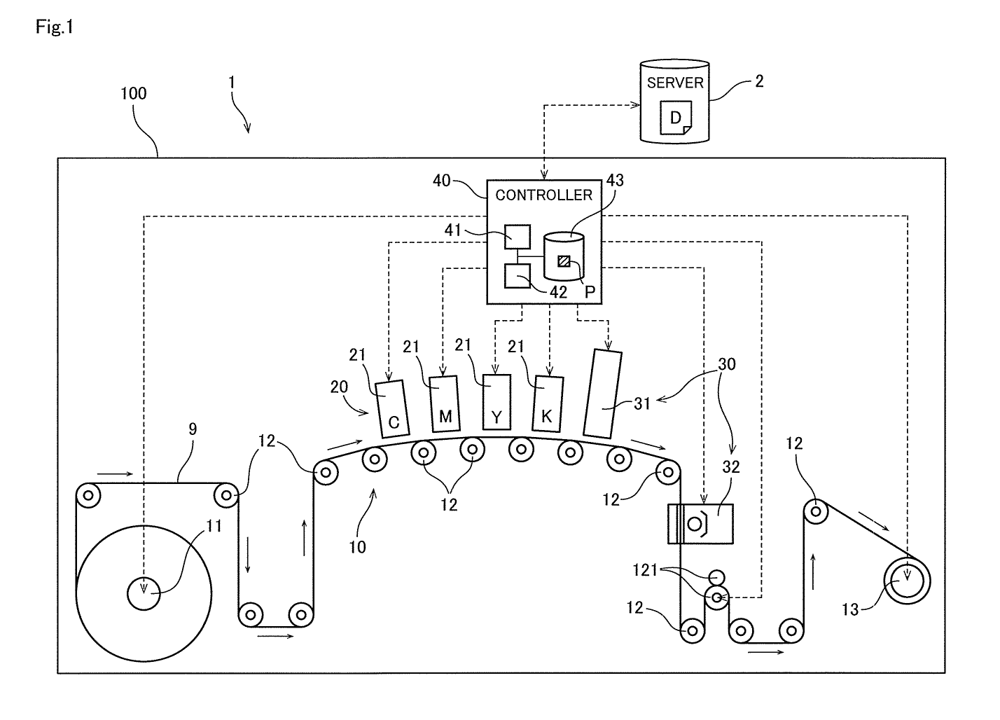

FIG. 1 is a diagram showing a configuration of an inkjet printer 1 according to one preferred embodiment of the present invention. This inkjet printer 1 is an apparatus which prints a multi-color image on printing paper 9 that is a strip-shaped recording medium by ejecting inks from a plurality of head units 21 toward the printing paper 9 while transporting the printing paper 9. As shown in FIG. 1, the inkjet printer 1 includes a transport mechanism 10, an image recorder 20, a light irradiator 30, and a controller 40. Of these components, at least the transport mechanism 10, the image recorder 20, and the light irradiator 30 are housed in a printer housing 100.

The transport mechanism 10 is a mechanism for transporting the printing paper 9 in a transport direction along the length of the printing paper 9. The transport mechanism 10 according to the present preferred embodiment includes an unwinder 11, a plurality of transport rollers 12, and a winder 13. The transport rollers 12 include nip rollers 121 to be described later. The printing paper 9 is unwound from the unwinder 11, and is transported along a transport path formed by the transport rollers 12. Each of the transport rollers 12 rotates about a horizontal axis to guide the printing paper 9 downstream along the transport path. The transported printing paper 9 is wound and collected on the winder 13.

As shown in FIG. 1, the printing paper 9 is moved substantially horizontally under the image recorder 20 in a direction in which the head units 21 are arranged. During this movement, a recording surface of the printing paper 9 faces upwardly (toward the head units 21).

The nip rollers 121 are disposed downstream from the light irradiator 30 to be described later along the transport path. The nip rollers 121 rotate actively at a constant speed while being in contact with the opposite surfaces of the printing paper 9 to hold the printing paper 9 therebetween. During the transport of the printing paper 9, the controller 40 adjusts the rotation speed of the unwinder 11 with respect to the rotation speed of the nip rollers 121. This applies tension to the printing paper 9. As a result, slack and wrinkles in the printing paper 9 are prevented during the transport.

The image recorder 20 is a mechanism for ejecting ultraviolet ray curable inks toward the printing paper 9 transported by the transport mechanism 10. The image recorder 20 according to the present preferred embodiment includes the four head units 21 arranged in the transport direction of the printing paper 9. The four head units 21 eject ink droplets of respective colors, i.e. C (Cyan), M (Magenta), Y (Yellow) and K (Black), which are color components of a multi-color image toward the recording surface of the printing paper 9. The head units 21 are disposed fixedly with respect to the printer housing 100.

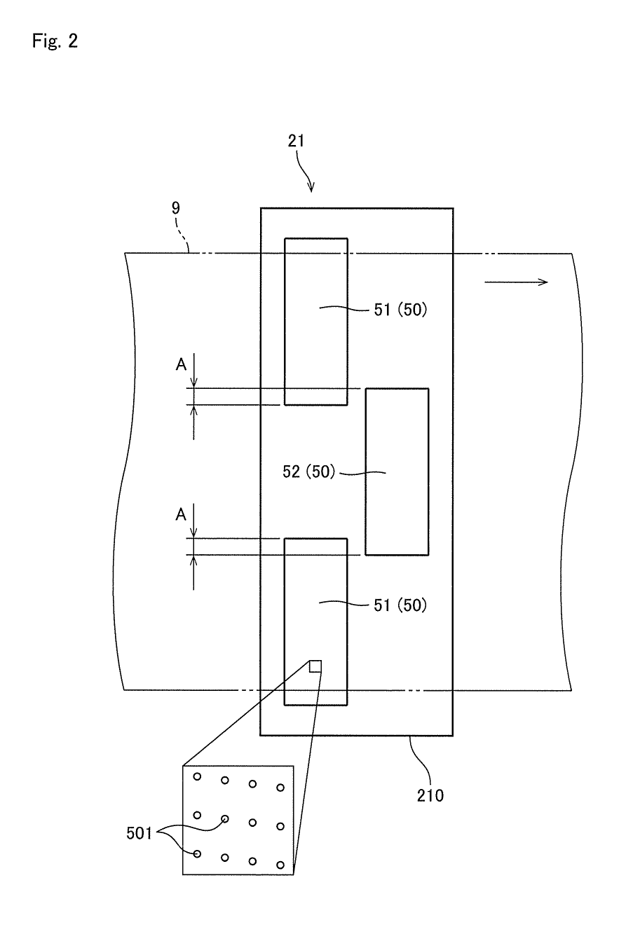

FIG. 2 is a bottom plan view of each of the head units 21. As shown in FIG. 2, each of the head units 21 according to the present preferred embodiment includes an enclosure 210, and three recording heads 50 fixed to the enclosure 210. Each of the three recording heads 50 has an exposed ejection surface at the lower surface of the enclosure 210. As shown in FIG. 2, the three recording heads 50 are displaced in relation to each other in the transport direction, and are displaced in relation to each other in a width direction (a horizontal direction perpendicular to the transport direction) of the printing paper 9 so as to cover the full area as seen in the width direction.

As shown on an enlarged scale in FIG. 2, the lower surface of each of the recording heads 50 has a plurality of nozzles 501 arranged in a regular alignment. The nozzles 501 are displaced in relation to each other in the width direction, and at least one of the nozzles 501 is assigned to a region having a width of one pixel on the printing paper 9. At the time of printing, ink droplets are ejected from the nozzles 501 of each of the recording heads 50 toward the recording surface of the printing paper 9. As a result, the four head units 21 record respective single-color images on the recording surface of the printing paper 9. A multi-color image is formed on the recording surface of the printing paper 9 by superimposing the four single-color images.

The three recording heads 50 according to the present preferred embodiment include two upstream heads 51 and one downstream head 52. The downstream head 52 is positioned downstream from the upstream heads 51 as seen in the transport direction of the printing paper 9. The two upstream heads 51 are disposed adjacent to and on opposite sides of the downstream head 52 as seen in the width direction. The widthwise positions (positions as seen in the width direction) of some of the nozzles 501 in the upstream heads 51 overlap the widthwise positions of some of the nozzles 501 in the downstream head 52. A widthwise range in which the overlapping ones of the nozzles 501 are present is referred to hereinafter as an “overlap region A”.

Referring again to FIG. 1, the light irradiator 30 includes a first light irradiator 31 positioned downstream from the image recorder 20 as seen in the transport direction, and a second light irradiator 32 downstream from the first light irradiator 31 as seen in the transport direction. The first light irradiator 31 directs light including ultraviolet rays, for example, from a plurality of LED light sources toward the recording surface of the printing paper 9. This places the inks on the printing paper 9 in a semi-cured state. The second light irradiator 32 directs light including ultraviolet rays, for example, from a metal halide lamp toward the recording surface of the printing paper 9. The amount of light from the second light irradiator 32 at the time of light emission is greater than the amount of light from the first light irradiator 31 at the time of light emission. Thus, when irradiated with light from the second light irradiator 32, the inks on the printing paper 9 are completely cured and fixed on the recording surface of the printing paper 9.

The controller 40 is a means for controlling the operations of the components in the inkjet printer 1. The controller 40 according to the present preferred embodiment is formed by a computer including a processor 41 such as a CPU, a memory 42 such as a RAM, and a storage part 43 such as a hard disk drive. As indicated by broken lines in FIG. 1, the controller 40 is electrically connected to the unwinder 11, the winder 13, the four head units 21, the first light irradiator 31, the second light irradiator 32, and the nip rollers 121. The controller 40 temporarily reads a computer program P stored in the storage part 43 onto the memory 42. The processor 41 performs arithmetic processing based on the computer program P, so that the controller 40 controls the operations of the aforementioned components. Thus, the printing process in the inkjet printer 1 proceeds.

The controller 40 is also connected to a server 2 provided outside the inkjet printer 1 for communication therewith. Image data D to be printed is stored in the server 2. For the printing process, the transport mechanism 10 transports the printing paper 9, and the controller 40 reads a designated piece of image data D from the server 2 to control the operation of ejecting the inks from the head units 21, based on the designated piece of image data D. As a result, an image corresponding to the designated piece of image data D is recorded on the recording surface of the printing paper 9.

<2. Proper Use of Nozzles in Overlap Region>

In the aforementioned overlap region A, ink is ejected from the nozzles 501 (referred to hereinafter as “upstream nozzles 511”) of the upstream heads 51 or the nozzles 501 (referred to hereinafter as “downstream nozzles 521”) of the downstream head 52. Each of the head units 21 in the inkjet printer 1 properly uses the upstream nozzles 511 and the downstream nozzles 521 in the widthwise positions included in the overlap region A to eject ink toward the recording surface of the printing paper 9. The proper use of the upstream nozzles 511 and the downstream nozzles 521 in the overlap region A will be described below.

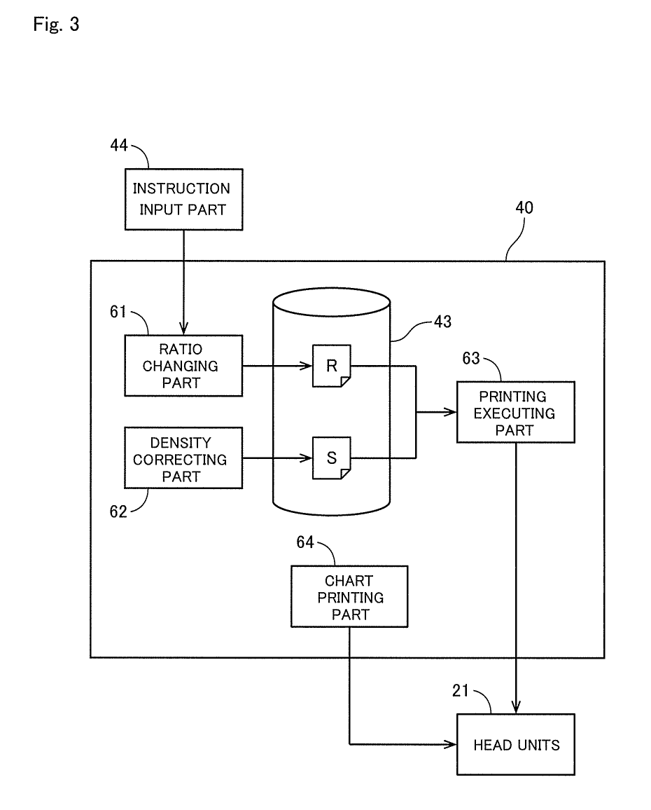

FIG. 3 is a block diagram conceptually showing functions of the controller 40 which relate to the proper use of the nozzles 501. As shown in FIG. 3, the controller 40 includes a ratio changing part 61, a density correcting part 62, a printing executing part 63, and a chart printing part 64. The controller 40 comes in operation, based on the computer program P, whereby the functions of these parts 61, 62, 63 and 64 are implemented.

The ratio changing part 61 is a processing part for changing a usage ratio R between the upstream nozzles 511 and the downstream nozzles 521 in the overlap region A. The initial value Ro of the usage ratio R is previously stored in the storage part 43 of the controller 40. A user of the inkjet printer 1 is allowed to input an update value R1 of the usage ratio R into the controller 40 through an instruction input part 44 (for example, a keyboard, a mouse or a touch panel display device) provided in the controller 40. When the update value R1 is inputted, the ratio changing part 61 rewrites the usage ratio R stored in the storage part 43 from the initial value Ro to the update value R1.

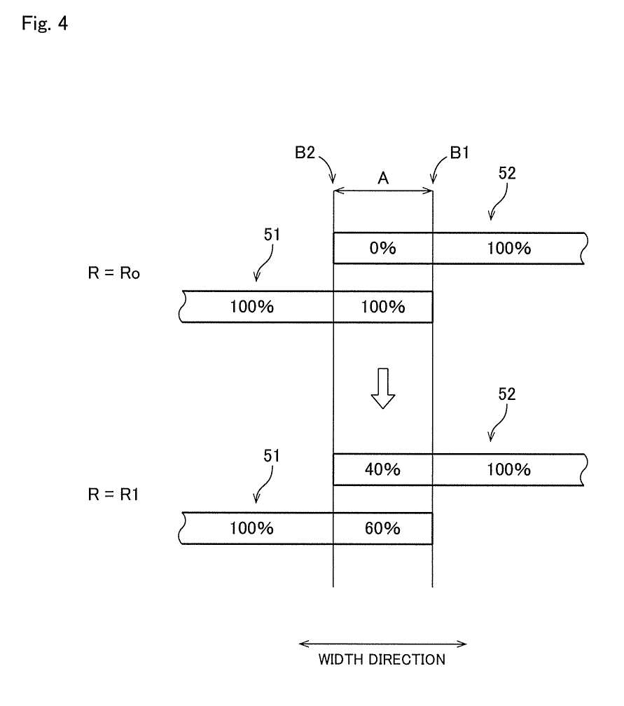

FIG. 4 is a diagram conceptually showing the process of rewriting the usage ratio R by means of the ratio changing part 61. The ratio in which ink to be ejected toward the widthwise positions of the printing paper 9 is to be shared between the upstream nozzles 511 and the downstream nozzles 521 is conceptually shown in FIG. 4. In the example of FIG. 4, the initial value Ro of the usage ratio R in the overlap region A is as follows:

Upstream nozzles: 100%

Downstream nozzles: 0%

That is, the ejection of ink in the overlap region A is carried out only by the upstream nozzles 511 when the usage ratio R takes the initial value Ro. In this case, the usage ratio R between the upstream nozzles 511 and the downstream nozzles 521 is changed only in one changing position B1 shown in FIG. 4. Accordingly, agglomeration around ejected ink is concentrated in the changing position B1.

In the example of FIG. 4, the update value R1 of the usage ratio R in the overlap region A is as follows:

Upstream nozzles: 60%

Downstream nozzles: 40%

This update value R1 means that the upstream nozzles 511 eject 60% of the ink to be ejected in the overlap region A and the downstream nozzles 521 eject 40% thereof. In this case, the usage ratio R between the upstream nozzles 511 and the downstream nozzles 521 is changed in two changing positions B1 and B2 (opposite ends of the overlap region A as seen in the width direction) shown in FIG. 4. Accordingly, the agglomeration of ink is distributed between the changing positions B1 and B2. This reduces the agglomeration of ink per changing position. As a result, the color irregularities are less prone to occur in each of the changing positions B1 and B2.

In this manner, the usage ratio R between the upstream nozzles 511 and the downstream nozzles 521 in the overlap region A is changeable in the inkjet printer 1. Thus, if color irregularities occur in the overlap region A, the inkjet printer 1 is capable of suppressing the color irregularities by changing the usage ratio R. The update value R1 of the usage ratio R is not limited to that in the aforementioned example (the upstream nozzles versus the downstream nozzles is 60% versus 40%), but may be set to an optimum value depending on the type of printing paper 9 and the type of ink. Alternatively, multiple candidates for the update value R1 may be previously prepared in the storage part 43, so that the user selects one candidate from among the multiple candidates.

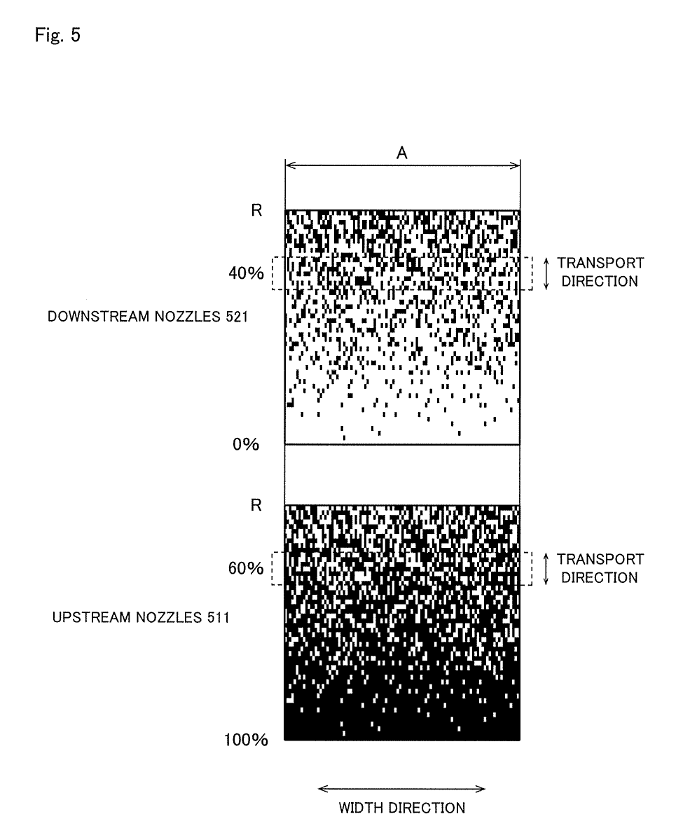

FIG. 5 shows a specific example of ejection patterns of the upstream nozzles 511 and the downstream nozzles 521 in the overlap region A after the usage ratio R is changed. The inkjet printer 1 previously stores such ejection patterns in the storage part 43 of the controller 40. In FIG. 5, the positions in which the upstream nozzles 511 or the downstream nozzles 521 eject ink in the widthwise positions included in the overlap region A are indicated by black areas (solidly shaded). The ejection pattern of the upstream nozzles 511 and the ejection pattern of the downstream nozzles 521 are in reverse relation to each other. Ejection patterns corresponding to multiple values of the usage ratio R are included in such ejection patterns.

The ratio changing part 61 selects a portion (for example, a portion surrounded by broken lines in FIG. 5) corresponding to the update value R1 of the usage ratio R from among such ejection patterns. Then, the ratio changing part 61 defines the selected pattern as the ejection patterns of the upstream nozzles 511 and the downstream nozzles 521. In this example, the upstream nozzles 511 and the downstream nozzles 521 are properly used in the widthwise positions in accordance with the positions of the printing paper 9 as seen in the transport direction. As viewed from the standpoint of one widthwise position, locations where ink is ejected from the upstream nozzles 511 and locations where ink is ejected from the downstream nozzles 521 are arranged in a random fashion in the transport direction. On the whole, the upstream nozzles 511 and the downstream nozzles 521 are properly used in the ratio of the designated update value R1.

Referring again to FIG. 3, the density correcting part 62 is a processing part for correcting the amounts of ink ejected from the upstream nozzles 511 and the downstream nozzles 521 in the aforementioned changing positions B1 and B2. The color irregularities in the changing positions B1 and B2 are reduced by the aforementioned rewriting of the usage ratio R. There are, however, cases in which color irregularities are slightly left in the changing positions B1 and B2, depending on the type of printing paper 9 and the type of ink. For example, the colors in the changing positions B1 and B2 become slightly darker in some cases. The density correcting part 62 makes the amounts of ink ejected from the upstream nozzles 511 and the downstream nozzles 521 responsible for the vicinities of the changing positions B1 and B2 smaller than the original amounts of ink depending on the image data D. This further reduces the color irregularities in the changing positions B1 and B2.

When the colors in the changing positions B1 and B2 become slightly lighter, the density correcting part 62 may make the amounts of ink ejected from the upstream nozzles 511 and the downstream nozzles 521 greater than the original amounts of ink depending on the image data D.

Specifically, the density correcting part 62 produces a correction instruction S for making the amounts of ink ejected from the upstream nozzles 511 and the downstream nozzles 521 responsible for the vicinities of the changing positions B1 and B2 smaller than the original amounts of ink depending on the image data D. Then, the density correcting part 62 stores the correction instruction S in the storage part 43.

The printing executing part 63 controls the operation of ejecting ink from each of the recording heads 50 of the head units 21, based on the image data D. At this time, the printing executing part 63 controls the operation of the upstream nozzles 511 and the downstream nozzles 521 in the overlap region A, based on the update value R1 of the usage ratio R and the correction instruction S both stored in the storage part 43. The upstream nozzles 511 and the downstream nozzles 521 eject ink in the ratio designated by the update value R1 toward the overlap region A. Also, the upstream nozzles 511 and the downstream nozzles 521 eject a corrected amount of ink based on the correction instruction S toward the vicinities of the changing positions B1 and B2. This provides a high-quality printed image with minor color irregularities.

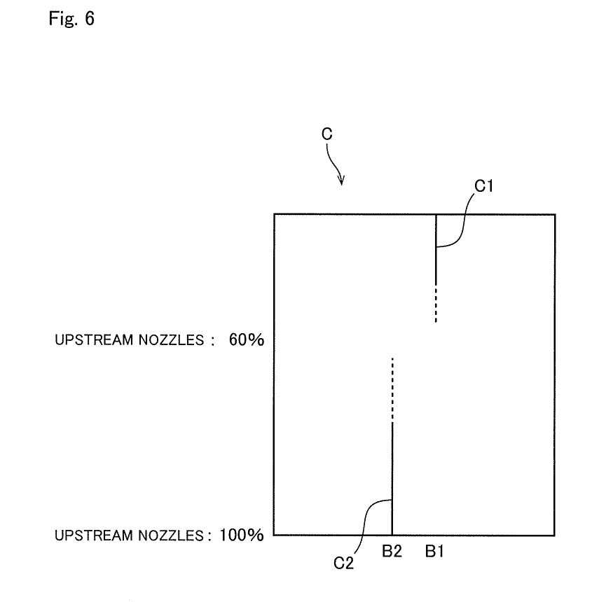

The chart printing part 64 is a processing part for printing a predetermined chart image C. FIG. 6 shows an example of the chart image C. While changing the aforementioned usage ratio R, the chart printing part 64 controls the head units 21 to cause the head units 21 to execute the printing of the chart image C. Specifically, the chart image C includes a plurality of portions different in usage ratio R from each other. For example, as shown in FIG. 6, a color irregularity C1 in the changing position B1 and a color irregularity C2 in the changing position B2 appear on the printed chart image C. The user views the chart image C to find the usage ratio R that minimizes the color irregularity C1 for the printing paper 9 and ink for practical use. This allows the user to input the optimum usage ratio R as the update value R1 into the instruction input part 44.

<3. Modifications>

While the one preferred embodiment according to the present invention has been described hereinabove, the present invention is not limited to the aforementioned preferred embodiment.

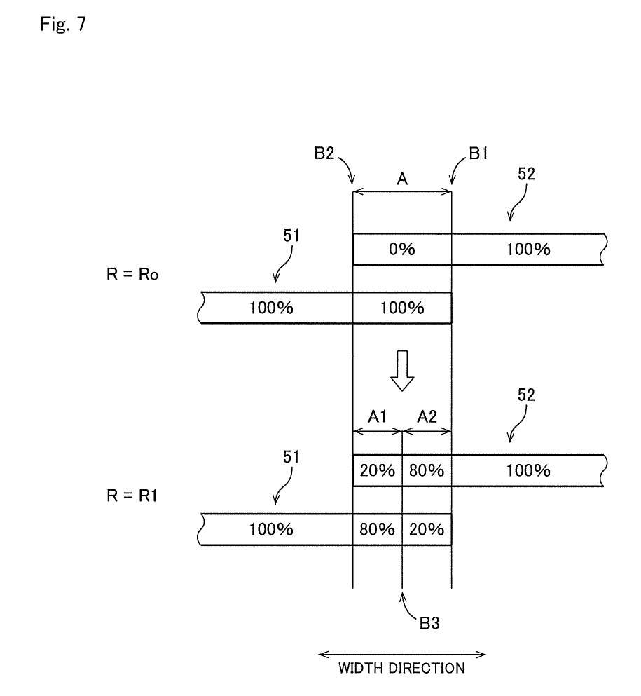

FIG. 7 is a diagram showing another example of the process of rewriting the usage ratio R by means of the ratio changing part 61. In the example shown in FIG. 7, the overlap region A is divided into two sub-regions A1 and A2 arranged in the width direction, and the usage ratio R is individually changed for each of the sub-regions A1 and A2. Specifically, the update value R1 of the usage ratio R in each of the two sub-regions A1 and A2 is as follows:

(Sub-region A1)

Upstream nozzles: 80%

Downstream nozzles: 20%

(Sub-region A2)

Upstream nozzles: 20%

Downstream nozzles: 80%

The upstream nozzles 511 eject 80% of the ink to be ejected in the sub-region A1 and the downstream nozzles 521 eject 20% thereof. The upstream nozzles 511 eject 20% of the ink to be ejected in the sub-region A2 and the downstream nozzles 521 eject 80% thereof. Thus, the usage ratio R between the upstream nozzles 511 and the downstream nozzles 521 is changed in three changing positions B1 to B3 shown in FIG. 7. The changing positions B1 and B2 are on opposite ends of the overlap region A as seen in the width direction, and the changing position B3 is on the boundary between the two sub-regions A1 and A2. Accordingly, the agglomeration of ink is distributed among the three changing positions B1 to B3. As a result, the color irregularities are less prone to occur in each of the changing positions B1 to B3.

The update value R1 of the usage ratio R in each of the sub-regions A1 and A2 is not limited to that in the aforementioned example, but may be set to an optimum value depending on the type of printing paper 9 and the type of ink. Alternatively, the overlap region A may be divided into three or more sub-regions A1 to An, so that the usage ratio R is changed more minutely. However, the increase in the number of sub-regions A1 to An increases the number of changing positions, and this may increase the processing burdens on the aforementioned density correcting part 62. For this reason, it is preferable that the number of sub-regions A1 to An is the lowest number that allows the color irregularities to fall within an allowable range.

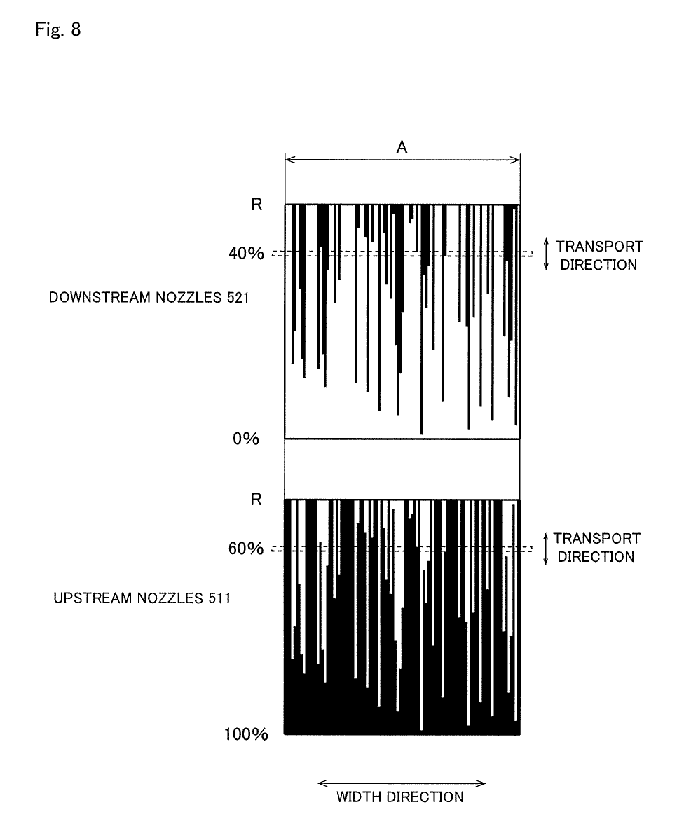

FIG. 8 shows another example of the ejection patterns of the upstream nozzles 511 and the downstream nozzles 521 in the overlap region A. In the example of FIG. 8, the ink ejection positions are arranged in the form of streaks, rather than in a random fashion. The ratio changing part 61 selects a portion (for example, a portion surrounded by broken lines in FIG. 8) corresponding to the update value R1 of the usage ratio R from among such ejection patterns. Then, the ratio changing part 61 defines the selected pattern as the ejection patterns of the upstream nozzles 511 and the downstream nozzles 521.

In the example of FIG. 8, the upstream nozzles 511 and the downstream nozzles 521 are properly used in accordance with the widthwise positions. Specifically, the ratio changing part 61 selects whether to use the upstream nozzles 511 or the downstream nozzles 521 for each of the widthwise positions included in the overlap region A. As viewed from the standpoint of one widthwise position, ink is ejected from either the upstream nozzles 511 or the downstream nozzles 521 independently of the positions as seen in the transport direction. On the whole, the upstream nozzles 511 and the downstream nozzles 521 are properly used in the ratio of the designated update value R1.

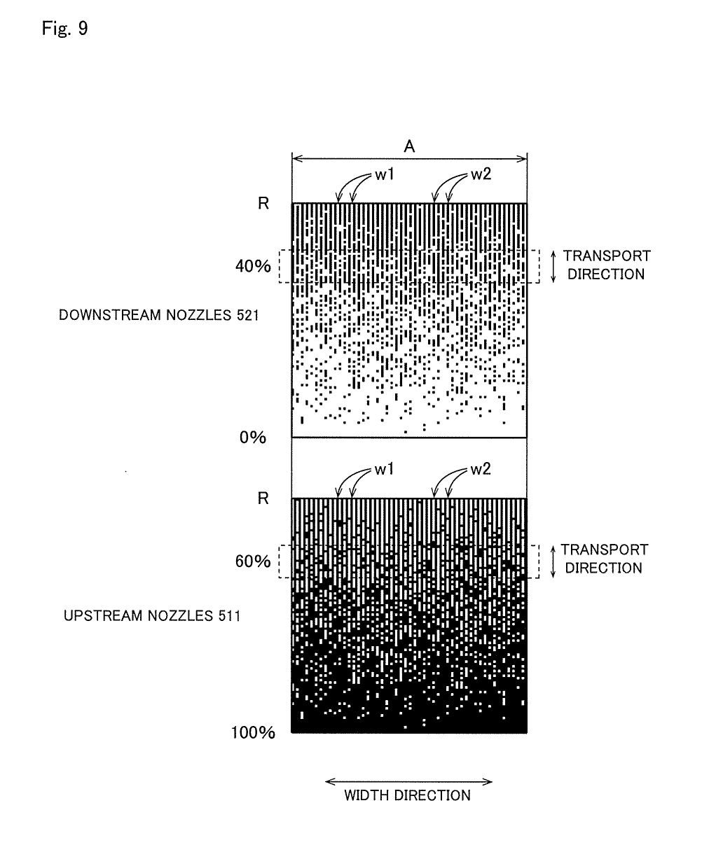

FIG. 9 shows still another example of the ejection patterns of the upstream nozzles 511 and the downstream nozzles 521 in the overlap region A. In the example of FIG. 9, the ink to be ejected toward some of the widthwise positions (for example, positions designated by w1 in FIG. 9) included in the overlap region A is always ejected from the upstream nozzles 511. The usage ratio R between the upstream nozzles 511 and the downstream nozzles 521 is changed in other widthwise positions (for example, positions designated by w2 in FIG. 9). Of the upstream nozzles 511 and the downstream nozzles 521 included in the overlap region A, there may be nozzles to which the change in usage ratio R by means of the ratio changing part 61 is not applied in this manner.

In the aforementioned preferred embodiment, the change in usage ratio R is made for each of the head units 21. However, the change in usage ratio R may be made for at least one of the head units 21 whereas the change in usage ratio R is not made for the remainder of the head units 21. For example, the change in usage ratio R may be made for only one head unit 21 which ejects ink earlier out of two head units 21. This reduces the agglomeration of the ink ejected earlier to suppress the occurrence of the color irregularities resulting from the ink of another color ejected over the earlier ejected ink. Also, the reduction in the number of head units 21 in which the change in usage ratio R is made suppresses the calculation and setting costs of the usage ratio R.

The head units 21 may have the same or different widthwise positions of the overlap region A. For example, one of the head units 21 and the remainder of the head units 21 may differ in widthwise positions of the overlap region A from each other. The widthwise positions of the overlap region A for the respective colors may be displaced in relation to each other, so that the color irregularities occurring in final printed products are reduced.

In the aforementioned preferred embodiment, the image recorder 20 includes the four head units 21. However, the number of head units in the image recorder 20 may be in the range of two to three or not less than five. For example, a head unit 21 for ejecting ink of a spot color may be provided in addition to those for C, M, Y and K. Also, in the aforementioned preferred embodiment, each of the head units 21 includes the three recording heads 50. However, the number of recording heads 50 in each of the head units 21 may be two or not less than four.

In the aforementioned preferred embodiment, the head units 21 provided in the fixed position eject inks toward the printing paper 9 transported by the transport mechanism 10. However, while moving in the transport direction, the head units 21 may eject inks toward the printing paper 9. In other words, the transport mechanism may move the printing paper 9 and the head units 21 relative to each other in the transport direction.

The ultraviolet ray curable inks are used in the aforementioned preferred embodiment. However, water-based inks that dry when exposed to air or when heated may be used in place of the ultraviolet ray curable inks. However, when the ultraviolet ray curable inks are used, the color irregularities are more prone to occur because the flowability of the inks on the surface of the printing paper 9 is less prone to decrease until the inks are irradiated with ultraviolet rays after the ejection of the inks. Thus, the present invention is especially useful.

The aforementioned inkjet printer 1 records an image on the printing paper 9 that is a recording medium. However, the inkjet printer according to the present invention may be configured to record an image on a strip-shaped recording medium other than general paper (for example, a film made of resin).

The structure of the details of the inkjet printer may be different from that shown in the figures of the present invention. The components described in the aforementioned preferred embodiment and in the modifications may be combined together, as appropriate, without inconsistencies.

While the invention has been described in detail, the foregoing description is in all aspects illustrative and not restrictive. It is understood that numerous other modifications and variations can be devised without departing from the scope of the invention.

What is claimed is:

1. An inkjet printer for printing a multi-color image on a recording medium, comprising:
a plurality of head units for ejecting respective inks of different colors toward the recording medium;
a transport mechanism for moving the recording medium and said head units relative to each other in a transport direction; and
a controller for controlling the operation of ejecting the inks from said head units,
each of said head units including
an upstream head, and
a downstream head adjacent to said upstream head as seen in a width direction orthogonal to said transport direction and positioned downstream from said upstream head as seen in said transport direction,
each of said upstream head and said downstream head including a plurality of nozzles arranged in said width direction,
some of said nozzles in said upstream head and some of said nozzles in said downstream head overlapping each other in widthwise position,
said controller including
a ratio changing part for changing a usage ratio between said nozzles in said upstream head and said nozzles in said downstream head in an overlap region that is a widthwise range in which the overlapping ones of said nozzles are present.

2. The inkjet printer according to claim 1, wherein
said ratio changing part changes said usage ratio uniformly in said overlap region.

3. The inkjet printer according to claim 1, wherein
said overlap region includes a plurality of sub-regions arranged in said width direction, and
said ratio changing part changes said usage ratio for each of said sub-regions.

4. The inkjet printer according to claim 1, wherein
said nozzles in said upstream head and said nozzles in said downstream head are properly used in said overlap region in accordance with the position of said recording medium as seen in said transport direction, and
said ratio changing part changes said usage ratio between said nozzles in said upstream head and said nozzles in said downstream head in the widthwise position of interest.

5. The inkjet printer according to claim 1, wherein
said nozzles in said upstream head and said nozzles in said downstream head are properly used in said overlap region in accordance with said widthwise position, and
said ratio changing part uses said nozzles in said upstream head or said nozzles in said downstream head for each widthwise position of interest.

6. The inkjet printer according to claim 1, wherein
the change in usage ratio by means of said ratio changing part is not applied to some of said nozzles in said upstream and downstream heads which are included in said overlap region.

7. The inkjet printer according to claim 1, wherein
said controller further includes
a density correcting part for correcting the amount of ink ejected from said nozzles in a changing position that is the widthwise position in which said usage ratio is changed.

8. The inkjet printer according to claim 1, wherein
said controller further includes
a chart printing part for executing the printing of a predetermined chart image while changing said usage ratio.

9. The inkjet printer according to claim 1, wherein
said ratio changing part changes said usage ratio for each of said head units.

10. The inkjet printer according to claim 1, wherein
said usage ratio is changed for only at least one of said head units which ejects ink earlier than the remainder of said head units.

11. The inkjet printer according to claim 1, wherein
one of said head units differs from the remainder of said head units in said widthwise position of said overlap region.

12. A method of inkjet printing a multi-color image on a recording medium by ejecting inks of different colors from respective head units toward the recording medium while moving the recording medium and the head units relative to each other in a transport direction, each of said head units including an upstream head, and a downstream head adjacent to said upstream head as seen in a width direction orthogonal to said transport direction and positioned downstream from said upstream head as seen in said transport direction, each of said upstream head and said downstream head including a plurality of nozzles arranged in said width direction, some of said nozzles in said upstream head and some of said nozzles in said downstream head overlapping each other in widthwise position, said method comprising the steps of:
a) changing a usage ratio between said nozzles in said upstream head and said nozzles in said downstream head in an overlap region that is a widthwise range in which the overlapping ones of said nozzles are present; and
b) ejecting said inks in the changed usage ratio from said upstream head and said downstream head.
